(19) United States
(12) Patent Application Publication
(10) Pub. No.: US 2025/0353392 A1
(43) Pub. Date: Nov. 20, 2025

(54) MODULAR DOCKING AND ENERGY MANAGEMENT SYSTEM FOR A SCOOTER OR BICYCLE

(71) Applicants: Chukwudi Okafor, London (GB); Vasyl PLAKHOTNIUK, London (GB); Francesco COSTACURTA, London (GB); Alberto TONINI, London (GB)

(72) Inventors: Chukwudi Okafor, London (GB); Vasyl PLAKHOTNIUK, London (GB); Francesco COSTACURTA, London (GB); Alberto TONINI, London (GB)

(21) Appl. No.: 18/835,383

(22) PCT Filed: Dec. 21, 2022
(86) PCT No.: PCT/GB2022/053337

§ 371 Date: Aug. 2, 2024

(51) Int. Cl. B60L 53/31; B60L 53/30; B60L 53/36; B60L 53/67; B60L 53/80; B62H 3/08; B62H 3/10

(52) U.S. Cl. CPC B60L 53/31; B60L 53/305; B60L 53/36; B60L 53/67; B60L 53/80; B62H 3/08; B62H 3/10; B60L 2200/12; B60Y 2200/126; B62H 2700/00

(57) ABSTRACT

The present disclosure provides a modular system for energy management and distribution, and for the docking of personal electric vehicles such as electric scooters and bicycles. The system comprises one or more core devices with polygonal frames. The edges of each frame are fitted with universal ports configured to couple with various external modules, including docking modules for different types of vehicles, to meet the demands of the space in which they are installed. The core devices have their own internal battery modules coupled to a power supply grid and implement smart charging protocols to store and discharge energy from their battery modules to connected external modules in an optimal manner. The system thus provides a versatile solution to the complex demands of city environments, both in terms of efficient and adaptable physical storage and varying power demands.

### CROSS REFERENCE TO RELATED APPLICATIONS

This patent application claims the benefit and priority of U.S. non-provisional patent application Ser. No. 17/669,996, filed 11 Feb. 2022.

### FIELD OF INVENTION

The present invention relates generally to the field of public docking and energy storage and distribution systems. More specifically the present invention relates to a modular docking, charging, and smart energy management system.

### BACKGROUND

The use of personal electric vehicles is becoming more and more ubiquitous, and this is a trend which shows no sign of slowing down, as light electric vehicles such as electric scooters and bicycles provide an energy efficient and convenient means of transport through congested environments such as big cities.

With this increase in usage, the storage of these vehicles has become an increasing logistical problem, alongside the ability to provide adequate charging points for them. Each type of vehicle requires large numbers of docking stations situated throughout a city in order to meet users' needs in a practical way, but these stations are costly and take up a great deal of space, requiring dedicated areas taking up expensive real estate.

A factor contributing to these issues is that current docking station solutions are rigid in their design, in that they are only able to accommodate certain brands or types of vehicle and need an area of appropriate shape and size to be installed. There is a need for a more versatile type of docking station, which can be adjusted both to suit the space it is being installed in and to meet the storage demands for that space, docking vehicles of different types in a consistent and space efficient manner.

A related problem is the complexity and inconsistency of city grid power supply lines. Fluctuating energy prices and demands can all too easily lead to enormous charging costs and, in emergencies, can cause grid failures when demand and resultant load on the grid is too high.

It is within this context that the present invention is provided.

### SUMMARY

The present disclosure provides a modular system for energy management and distribution, and for the docking of personal electric vehicles such as electric scooters and bicycles. The system comprises one or more core devices with polygonal frames. The edges of each frame are fitted with universal ports configured to couple with various external modules, including docking modules for different types of vehicles, to meet the demands of the space in which they are installed. The core devices have their own internal battery modules coupled to a power supply grid and implement smart charging protocols to store and discharge energy from their battery modules to connected external modules in an optimal manner. The system thus provides a versatile solution to the complex demands of city environments, both in terms of efficient and adaptable physical storage and varying power demands.

According to a first aspect of the present disclosure, there is provided a docking and energy management system. The system comprises at least one core device, each core device of the system comprising: a frame having a polygonal profile with a plurality of straight edges of equal length; a set of one or more anchor elements configured to secure the frame to the ground; a battery module disposed within the frame and coupled to a grid power source; a controller coupled to the battery module and configured to control charging of the battery module from the grid and the distribution of energy stored in the battery module to one or more external modules; a plurality of ports, each port corresponding to a respective edge of the frame and being configured to securely couple to an external module via a universal coupling mechanism, and to thereby connect coupled external modules to the battery module and controller of the core device; and one or more protective panels configured to detachably couple to the frame to protect unused ports.

The system also comprises a plurality of external modules, including at least one docking module configured to dock and charge a personal electric vehicle when coupled to a port of a core device.

In some embodiments, the system comprises a cluster of two or more core devices coupled to one another via a connector, the connector facilitating energy exchange between the battery modules of the coupled core devices as controlled by the respective controllers.

In some embodiments, the controller is configured to wirelessly communicate with one or more external devices to coordinate the charging of its respective battery module and the distribution of energy from the battery module to the one or more external modules and/or to balance grid load.

Furthermore, the controller may interface with a cloud network architecture to coordinate one or more operations of the external modules.

In some embodiments, the one or more docking modules each comprise a motorized assembly, locking mechanism, and at least one wheel sensor, and wherein the controller is configured to operate the docking modules to perform an assisted docking operation in response to a detection from the wheel sensor.

In some embodiments, the one or more docking modules include a scooter docking module. They may also include a bike docking module and/or an electric vehicle charging module.

In some embodiments, the one or more external modules include a display module comprising a touchscreen interface and which is configured to display one or more metrics or instructions received from the controller when coupled to a respective port of the core device.

In some embodiments, the one or more external modules include a charger module comprising a plurality of charging docks for electric vehicle fuel cell batteries to facilitate the exchange of spent fuel cells for charged fuel cells, each charging dock comprising a locking mechanism operated by the core device controller.

In some embodiments, the controller is configured to monitor any external modules coupled to a port for status, errors, and battery levels of charging or docked devices.

In some embodiments, each core device further comprises a detachable top lid.

Furthermore, each core device may further comprise a utility chamber disposed within the frame below the top lid, the utility chamber being configured to hold personal vehicle servicing products and accessories.

In such embodiments, the utility chamber may be mounted on a motorized assembly controlled by the core device controller, the controller being configured to operate the actuators to raise the utility chamber up towards the top of the frame in response to a detection that the top lid has been removed.

In some embodiments, the one or more protective panels are provided with decorative designs.

In some embodiments, the polygonal profile is one of a hexagonal, triangular, or square profile.

### BRIEF DESCRIPTION OF THE DRAWINGS

Various embodiments of the invention are disclosed in the following detailed description and accompanying drawings.

FIG. 1 illustrates an isometric view of an example configuration of a core device of the disclosed system.

FIG. 2 illustrates an isometric view of the example core device with the exterior protective panels removed and a utility chamber being raised by a motorized assembly.

FIG. 3 illustrates an isometric view of the example core device with a scooter docking module installed in one of its ports.

FIG. 4 illustrates an isometric view of the example core device with a bicycle docking module installed in one of its ports.

FIG. 5 illustrates an isometric view of a pair of example core devices coupled together by a set of connectors.

FIG. 6 illustrates the coupled core devices of FIG. 5 with the protective panels of the core devices removed.

FIG. 7 illustrates an alternative configuration where a pair of core devices are connected by adjacent edges.

FIG. 8 illustrates an isometric view of an example core device with a scooter module and bicycle module installed in adjacent ports.

FIG. 9 illustrates an isometric view of a set of three core devices coupled together in a cluster, with a pair of adjacent core devices having display modules installed on their ports and a third core device having a set of bicycle modules installed in its ports.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

Spatially relative terms, such as “under,” “below,” “lower,” “over,” “upper” and the like, may be used herein for ease of description to describe one element or feature's relationship to another when the apparatus is right side up.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

The present disclosure provides a novel design for a personal electric vehicle docking station which utilizes polygonal supersymmetry and universal modular port connections to dock and charge vehicles in a space-efficient and adaptable manner to suit its environment. The inclusion of internal battery modules for smart charging and power distribution also enables the station to act as a grid balancing system and facilitates much more cost-efficient energy usage. The smart controller regulating the charging and distribution may also communicate with a cloud network architecture to implement various operations in controlling external modules attached to the core devices.

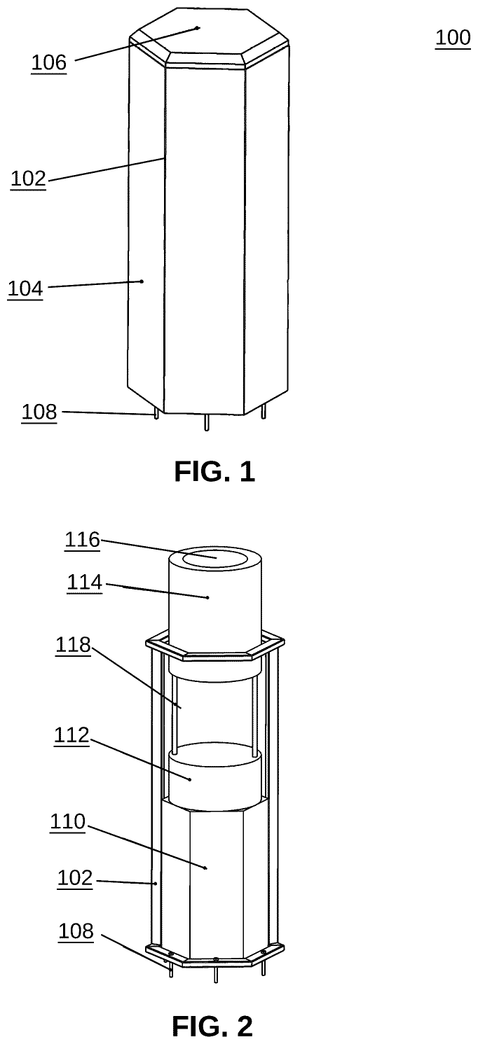

Referring to FIG. 1 and FIG. 2, first and second isometric views are shown of an example configuration of a core device 100 of the disclosed system. FIG. 1 shows device 100 with protective panels 104 installed and FIG. 2 shows them removed.

As can be seen, the core device 100 comprises a frame 102 with a polygonal profile or cross-section, in this case a hexagonal one. This could equally be more compact, taking a triangular or square shape, or extended to a many-sided polygon. Each side of the polygon comprises an identical port configured to receive an external module, and which is covered by detachable protective panels 104 when not in use. Protective panels 104 may comprise designs such as advertising designs. In the present example, the top of the core device 100 also comprises a removable lid 106. The frame 102 of the core device 100 is anchored to the ground by a set of anchoring elements 108 to prevent theft.

Internally, the core device 100 comprises a battery module 110. The battery module is coupled to a power supply grid and configured to draw power therefrom, storing the power for distribution to external modules attached to the ports and, in emergencies, is able to return power to the grid for load balancing. Coupled to the battery module 110 is a controller 112. The controller is a processing apparatus that monitors and controls the charging and energy distribution of the battery module to the external modules while also controlling the external modules and collecting data on their operations. The controller 112 is wirelessly enabled and may communicate with user devices and other core modules via a cloud network architecture to implement various features.

In the present example, the core device 100 also comprises a utility chamber 114. The utility chamber rests beneath the removable lid 106, and comprises a hollow space 116 for storing various accessories and products such as vehicle maintenance and cleaning products/tools. The utility chamber 114 is mounted to a set of motorized actuators 118, operated by the controller 112. The controller may be configured to either receive a command over the cloud network or detect that the lid 106 has been opened and, in response, cause the actuators 118 to raise the utility chamber 114 out of the core device 100 as shown for easy access to the stored products.

A key advantage of the disclosed system is that each port/edge of a core module 100 is equipped with a universal dock that can securely couple an external module to both the controller 112 and the battery module 110, according to the needs of the environment.

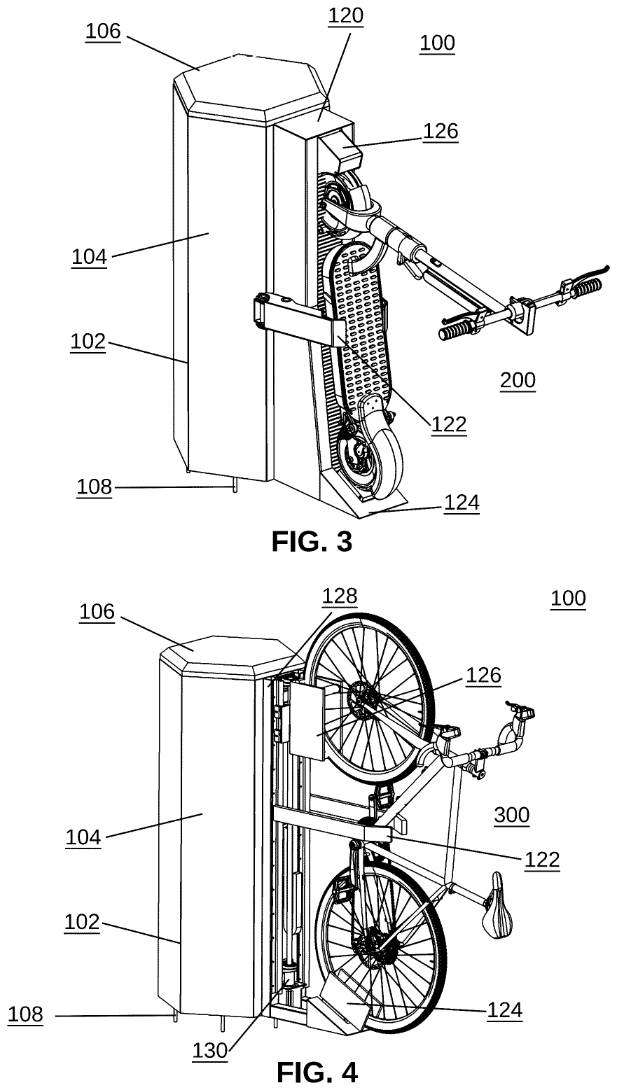

Referring to FIG. 3 and FIG. 4, isometric views are shown of the example core device 100 with a scooter docking module 120 installed in one of its ports and a bicycle docking module 128 installed in one of its ports. A scooter vehicle 200 and bicycle 300 are installed in the respective docking modules. The ability to dock different types of vehicles at the same core device according to demand is highly advantageous.

In each case, the protective panel for that port has been removed, and the module 120/128 has been locked in place at the port, giving it access to the power distributed by the battery module 110 and allowing the controller 112 to control and monitor its operations.

For docking modules such as those shown, the external module will generally comprise a front wheel clamp 126, a locking mechanism 122, and a back wheel clamp 124. The module will also comprise a motorized assembly, powered by the module's connection to the battery module and controlled by the controller, which together with the clamps and locking mechanisms facilitate assisted docking processes to raise docked personal electric vehicles into vertical positions as shown. This creates a more space-efficient storage arrangement for docked vehicles than prior art solutions and does not require a user to lift the vehicles with their own strength. The docking modules may, for assisting in this purpose, comprise wheel sensors to detect when a front wheel of a horizontal vehicle ready to be docked is in position, causing the controller to begin the assisted docking process of clamping the front wheel and raising it up via the motorized assembly.

The above operations may be controlled by a user interfacing with an app or platform via the cloud network to book a space at the docking station and entering or scanning a code at the station or on their user device.

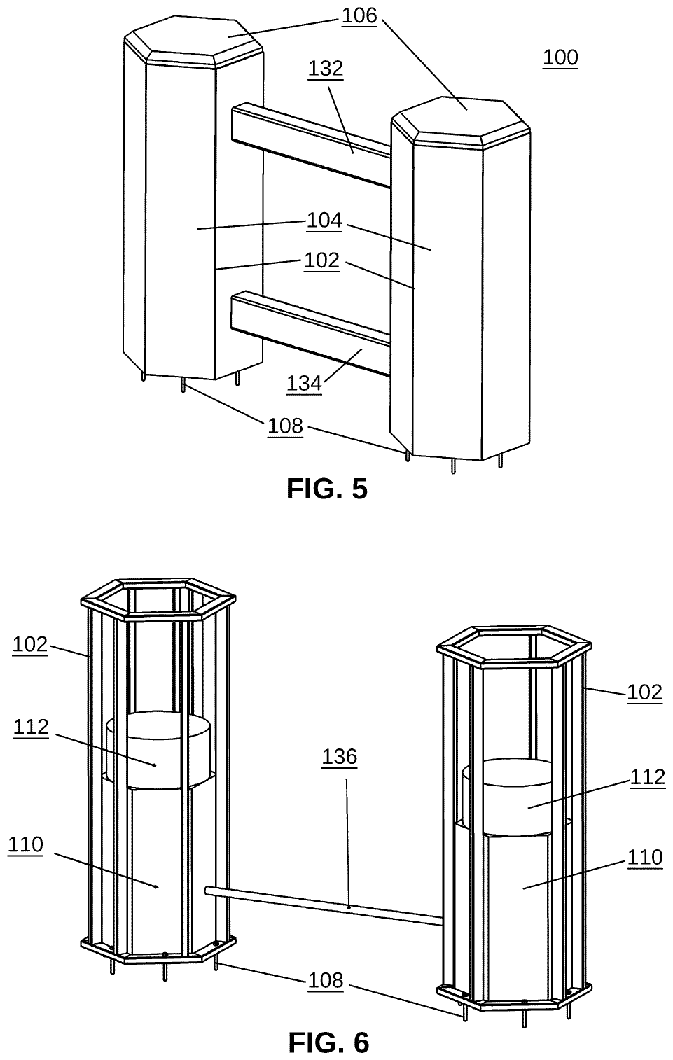

As mentioned above, a key advantage of the disclosed modular docking system is its versatility. Some spaces may require large numbers of vehicle spaces or other module functions as will be described below. To facilitate this, multiple core devices 100 can be coupled together as shown in FIG. 5.

Core devices are coupled together from edge to edge by connectors, such as the upper connector 132 and lower connector 134. This type of modular connectivity allows clusters of core devices 100 to be positioned in a shape that fits tight spaces but can be extended in any direction according to demand.

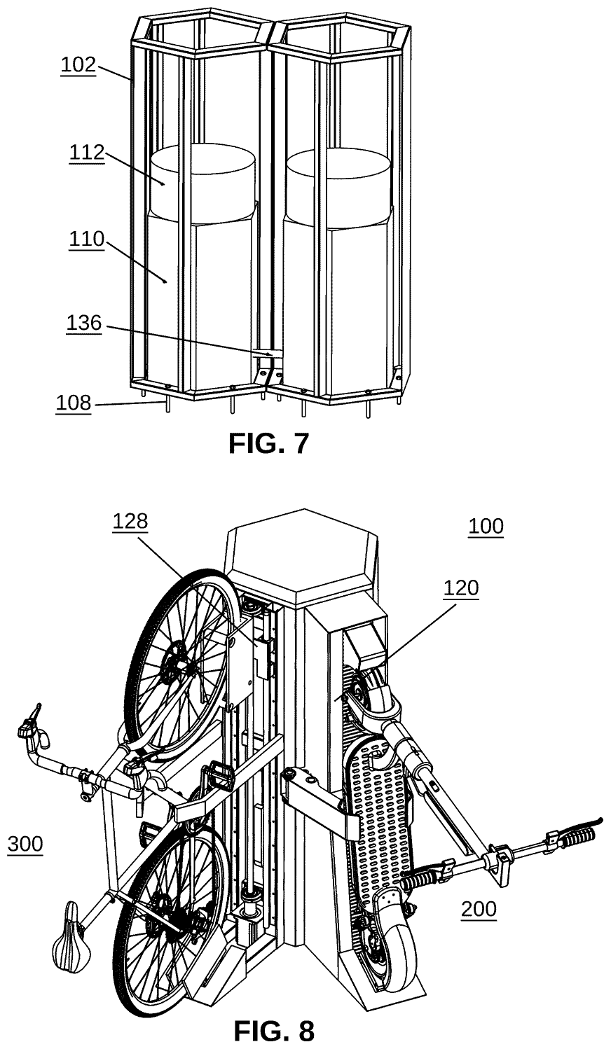

Referring to FIG. 6 and FIG. 7, two example configurations of connected core devices 100 are shown with the protective panels 104 removed. As can be seen, the core devices can either have separate frames 102 and be connected only via the connections 136 as shown in FIG. 6, or they can also have their frames 102 connected along a shared edge as shown in FIG. 7.

Connections 136 couple the battery modules 110 of the respective core devices to one another, allowing power to be distributed back and forth freely between them as energy demands on their respective external modules shift. These power exchanges would be controlled by the controller 112, and in cases where a cluster of core devices coordinate with one another, one controller 112 may operate as the “master” with the remaining controllers of the core devices in the cluster operating as “slaves”.

Referring to FIG. 8, an isometric view is shown of an example core device 100 with two different modules, a scooter docking module 120 and a bicycle docking module 128, attached to adjacent ports.

As can be seen, the storage provided by the core device 100 only takes up the absolute minimum in terms of physical space footprint once the vehicles are docked, allowing for it to be installed in various areas of packed city environments that would be impossible for prior art solutions.

Docking modules are not the only types of external modules that can be installed in the core devices. Indeed, the core devices 100 effectively provide a versatile power source for public spaces that can effectively power any type of operation. Since the power distribution is controlled by a smart controller that may be configured to draw power from the power supply grid only at optimum times, and then distribute power from the battery module when grid power is expensive, modules may be created to couple to the core and perform any kind of electrically powered operation more efficiently.

An example of another type of module that could be utilized is a detachable display module comprising a touchscreen interface and which is configured to display one or more metrics or instructions received from the controller when coupled to a respective port of the core device.

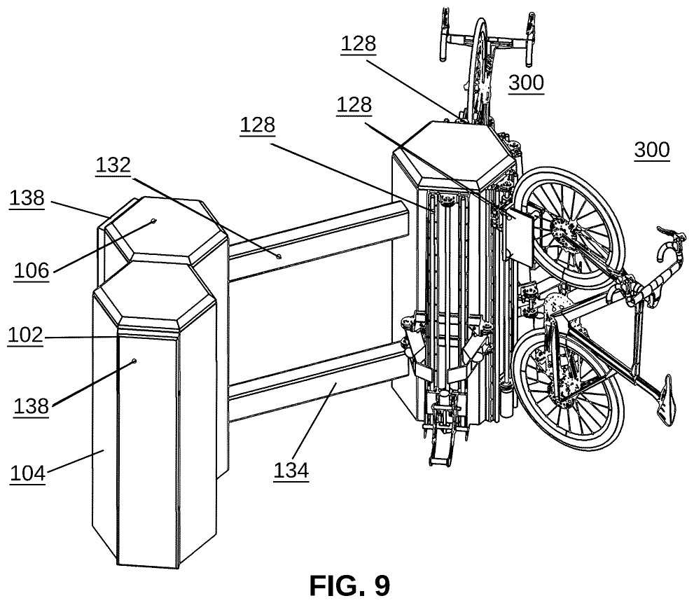

Referring to FIG. 9, an isometric view is shown of a set of three core devices 100 coupled together in a cluster, with a pair of adjacent core devices 100 having display modules 138 installed on their ports and a third core device 100 having a set of bicycle modules 128 with docked bicycles 300 installed in its ports.

This example begins to show the true versatility of the disclosed system, which can be extended in any direction to utilize space in an optimum way and can have functional modules installed according to demand.

The controllers of the core devices may monitor various parameters in relation to each connected external module, including the charging status of any docked devices, any errors in their operation, etc.

Although not shown, another example type of external module that could be installed in the core devices is a charger module comprising a plurality of charging docks for electric vehicle fuel cell batteries to facilitate the exchange of spent fuel cells for charged fuel cells, each charging dock comprising a locking mechanism operated by the core device controller.

A controller as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated computer systems with hard-wired logic or programs stored in non-volatile memory, such as, by way of example, read-only memory (ROM).

In some embodiments, features of the computer systems can be implemented primarily in hardware using, for example, hardware components such as application specific integrated circuits (ASICs) or field-programmable gated arrays (FPGAs). Implementation of the hardware circuitry will be apparent to persons skilled in the relevant art(s). In yet another embodiment, features of the computer systems can be implemented using a combination of both general-purpose hardware and software

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A docking and energy management system, comprising:
at least one core device, each core device of the system comprising:
a frame having a polygonal profile with a plurality of straight edges of equal length;
a set of one or more anchor elements configured to secure the frame to the ground;
a battery module disposed within the frame and coupled to a grid power source;
a controller coupled to the battery module and configured to control charging of the battery module from the grid and the distribution of energy stored in the battery module to one or more external modules;
a plurality of ports, each port corresponding to a respective edge of the frame and being configured to securely couple to an external module via a universal coupling mechanism, and to thereby connect coupled external modules to the battery module and controller of the core device; and
one or more protective panels configured to detachably couple to the frame to protect unused ports;
and
a plurality of external modules, including at least one docking module configured to dock and charge a personal electric vehicle when coupled to a port of a core device.

2. A docking and energy management system according to claim 1, wherein the system comprises a cluster of two or more core devices coupled to one another via a connector, the connector facilitating energy exchange between the battery modules of the coupled core devices as controlled by the respective controllers.

3. A docking and energy management system according to claim 1, wherein the controller is configured to wirelessly communicate with one or more external devices to coordinate the charging of its respective battery module and the distribution of energy from the battery module to the one or more external modules and/or to balance grid load.

4. A docking and energy management system according to claim 3, wherein the controller interfaces with a cloud network architecture to coordinate one or more operations of the external modules.

5. A docking and energy management system according to claim 1, wherein the one or more docking modules each comprise a motorised assembly, locking mechanism, and at least one wheel sensor, and wherein the controller is configured to operate the docking modules to perform an assisted docking operation in response to a detection from the wheel sensor.

6. A docking and energy management system according to claim 1, wherein the one or more docking modules include a scooter docking module.

7. A docking and energy management system according to claim 1, wherein the one or more docking modules include bike docking module.

8. A docking and energy management system according to claim 1, wherein the one or more docking modules include an electric vehicle charging module.

9. A docking and energy management system according to claim 1, wherein the one or more external modules include a display module comprising a touchscreen interface and which is configured to display one or more metrics or instructions received from the controller when coupled to a respective port of the core device.

10. A docking and energy management system according to claim 1, wherein the one or more external modules include a charger module comprising a plurality of charging docks for electric vehicle fuel cell batteries to facilitate the exchange of spent fuel cells for charged fuel cells, each charging dock comprising a locking mechanism operated by the core device controller.

11. A docking and energy management system according to claim 1, wherein the controller is configured to monitor any external modules coupled to a port for status, errors, and battery levels of charging or docked devices.

12. A docking and energy management system according to claim 1, wherein each core device further comprises a detachable top lid.

13. A docking and energy management system according to claim 12, wherein each core device further comprises a utility chamber disposed within the frame below the top lid, the utility chamber being configured to hold personal vehicle servicing products and accessories.

14. A docking and energy management system according to claim 13, wherein the utility chamber is mounted on a motorised assembly controlled by the core device controller, the controller being configured to operate the actuators to raise the utility chamber up towards the top of the frame in response to a detection that the top lid has been removed.

15. A docking and energy management system according to claim 1, wherein the one or more protective panels are provided with decorative designs.

16. A docking and energy management system according to claim 1, wherein the polygonal profile is one of a hexagonal, triangular, or square profile.
